(19) United States
(12) Patent Application Publication
(10) Pub. No.: US 2026/0147402 A1
(43) Pub. Date: May 28, 2026

(54) POWER CAPPING IN A COMPUTING SYSTEM

(71) Applicant: HEWLETT PACKARD ENTERPRISE DEVELOPMENT LP, Spring, TX (US)

(72) Inventor: Melvin K. Benedict, Magnolia, TX (US)

(21) Appl. No.: 18/894,776

(22) Filed: Sep. 24, 2024

(51) Int. Cl. G06F 1/3296; G06F 1/3206

(52) U.S. Cl. CPC G06F 1/3296; G06F 1/3206

(57) ABSTRACT

In some examples, a controller activates, as a response to an event, a power control signal to the processing resource through the interface, the activated power control signal to place the processing resource in a reduced power mode. The controller updates a value of a resource power capping parameter in an iterative power adjustment process. In an iteration of the iterative power adjustment process, the controller provides the updated value of the resource power capping parameter to the processing resource to set a power consumption cap of the processing resource.

### BACKGROUND

A computing system includes various electronic components that can consume power during operation. The amount of power drawn by an electronic component is based on an operating frequency of the electronic component and A power supply voltage level supplied to the electronic component.

### BRIEF DESCRIPTION OF THE DRAWINGS

Some implementations of the present disclosure are described with respect to the following figures.

FIG. 1 is a block diagram of a computing system including a management controller to apply power consumption capping of a processing resource, according to some examples.

FIG. 2 is a flow diagram of a power capping process, according to some examples.

FIG. 3 is a block diagram of a controller according to some examples.

FIG. 4 is a block diagram of a computing system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Capping of the power consumed by a computing system can be performed in several scenarios. For example, power consumption may be capped in response to a rise in the temperature of the computing system above a temperature threshold. As another example, a failure of one or more power supplies for the computing system may lead to errors or faults in the computing system if the computing system were to attempt to draw more power than what the remaining power supply (or supplies) can provide, which may cause the remaining power supply (or supplies) to trip and stop functioning. As further examples, power consumption capping may be performed for the following reasons: to prevent total power consumption of the computing system from rising above a threshold, to change a power consumption of the computing system due to a change in a power allocation for the computing system in a computing environment, or any other reason.

Some example power capping techniques modulate the duty cycle of a control signal to a processor of a computing system to control how much power is consumed by the processor. An example of such a control signal is referred to as a PROC_HOT (processor hot) signal (or alternatively, a stop clock signal). A duty cycle of the PROC_HOT signal refers to the ratio of time that the PROC_HOT signal is active relative to the time that the PROC_HOT signal is inactive. When the PROC_HOT signal is active, the processor is operated in a reduced power mode. However, modulating the duty cycle of the PROC_HOT signal may not work with certain types of processors from some vendors.

Other example power capping techniques manage the performance states of the processor in the computing system. For example, the Advanced Configuration and Power Interface (ACPI) Specification defines various performance states, including ACPI P states (power performance states) for scaling the frequency and voltage at which the processor runs. As another example, ACPI C states (processor idle sleep states) control which parts of the processor are turned off. However, a processor may react slowly to a change in ACPI states, which may not be satisfactory in situations where the processor has to transition to a different power state relatively quickly in response to an event.

In accordance with some implementations of the present disclosure, a management controller responds to a critical power event by using a combination of a quick reaction power reduction process and a slower iterative power adjustment process. A “quick reaction” power reduction process refers to a process that causes a target electronic component, such as a processing resource (or multiple processing resources), to reduce the target electronic component's power consumption in less than a specified reaction time duration, such as any of the following: less than 200 milliseconds (ms), less than 100 ms, less than 50 ms, less than 30 ms, less than 20 ms, less than 10 ms, less than 5 ms, or any other time duration.

The quick reaction power reduction process includes activating a power control signal (e.g., a PROC_HOT signal) to a processing resource to quickly place the processing resource in a minimum power mode (or another reduced power mode). Along with the quick reaction power reduction process, the management controller triggers the iterative power adjustment process that iteratively updates (possibly in multiple iterations) a value of a resource power capping parameter that is used by the processing resource in setting a power consumption cap of the processing resource. The ability to react quickly to a critical power event increases the likelihood that a computing system does not draw too much power that may lead to a fault or other issue in the computing system. Examples of critical power events can include any or some combination of the following: a failure or fault of one or more power supplies in the computing system (e.g., if a redundant mode is not implemented where one power supply can take over providing power for a failed power supply), a temperature of the computing system exceeding a temperature threshold, a current power consumption of the computing system exceeding a threshold, or any other event relating to excessive power use.

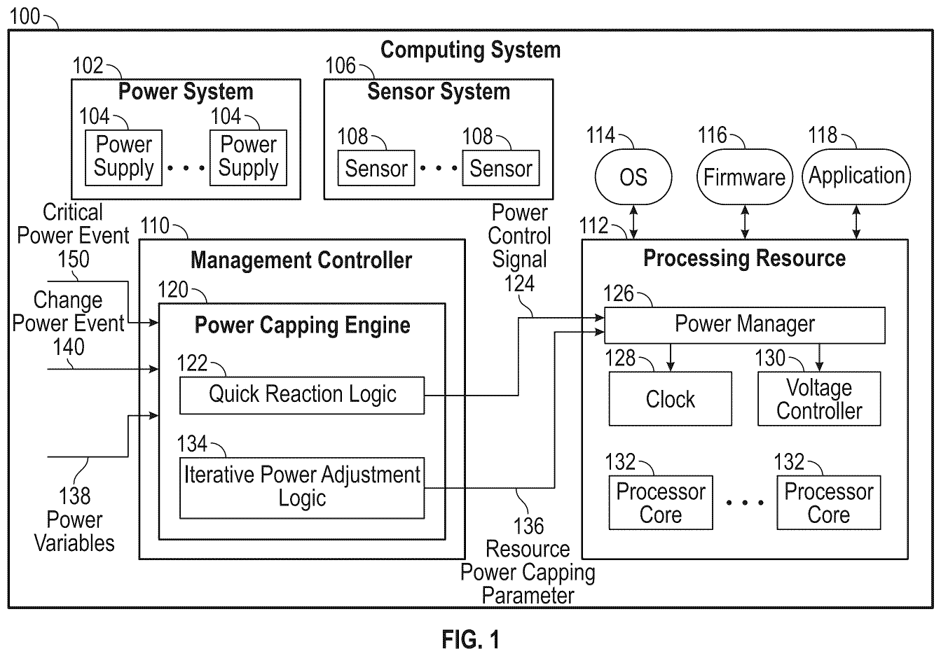

FIG. 1 is a block diagram of a computing system 100, which can include one or more compute elements. The computing system 100 includes a power system 102 having a number of (one or more) power supplies 104. A power supply generates a power supply voltage used to power electronic components of the computing system 100. The power supply may include an AC power adapter, a battery, or any other source of power.

The computing system 100 also includes a sensor system 106 including sensors 108 that are used to measure various properties of the computing system 100. A sensor can refer to a hardware sensor or a software sensor. As examples, a power sensor can measure a power consumption of the computing system 100 (or a portion of the computing system 100), a temperature sensor can measure a temperature in the computing system 100 (or a portion of the computing system 100), and so forth.

The computing system 100 includes a management controller 110 that performs management tasks of the computing system 100. An example of the management controller 110 is a baseboard management controller (BMC). In other examples, other types of management controllers 110 can be employed. The management controller 110 is separate from a processing resource 112 of the computing system 100.

A “processing resource” can refer to a resource that performs designated tasks in the computing system 100. In some examples, the processing resource 112 is able to execute machine-readable instructions. In other examples, the processing resource 112 is a hardware processing resource including hardware processing circuitry configured to perform various tasks. The processing resource 112 may be in the form of an integrated circuit device, a system-on-a-chip (SoC) device, a circuit board on which are mounted components, or any other assembly of components.

The processing resource 112 may include a central processing unit (CPU), which executes primary instructions of the computing system 100. The primary instructions include an operating system (OS) 114, system firmware 116 (e.g., Basic Input/Output System (BIOS) code), and/or an application program 118. The primary machine-readable instructions are distinct from management machine-readable instructions executed by the management controller 110, for example. In other examples, the processing resource 112 can execute other types of machine-readable instructions, such as machine-readable instructions associated with performing network communications, graphics processing, machine learning, and so forth. In further examples, the processing resource 112 may include a graphics processing unit (GPU), a neural processing unit (NPU), or any other type of processing resources.

Although just one processing resource 112 is shown in FIG. 1, in other examples, there may be multiple processing resources in the computing system 100 subject to power consumption capping performed by a power capping engine 120 of the management controller 110. The power capping engine 120 includes quick reaction logic 122 that performs the quick reaction power reduction process in response to a critical power event 150. The critical power event 150 can include a signal (e.g., an interrupt signal or another type of signal), a message, an information element, or any other indicator.

In an example, the critical power event 150 may have been triggered in response to failure or fault of one or more of the power supplies 104 (e.g., if redundant mode is not implemented). The management controller 110 may monitor the power system to detect any failure or fault of power supplies 104. A detected power supply failure or fault triggers the critical power event 150 in the management controller 110.

As another example, the critical power event 150 may have been triggered based on a temperature provided by a temperature sensor exceeding a threshold. The critical power event 150 may include a signal or another indicator that is activated in response to the temperature exceeding the threshold.

As yet a further example, the critical power event 150 may be triggered in response to an overall power consumption of the computing system 100 exceeding a critical power threshold. Other conditions of the computing system 100 may trigger the critical power event 150. More generally, the critical power event 150 indicates that a power-related condition has occurred that may cause insufficient power delivery to components of the computing system 100, which can lead to loss of data, damage to the computing system 100, or any other fault or error. The critical power threshold is used to trigger the power reduction of the processing resource 112 as well as input/output (I/O) components.

The quick reaction logic 122 is able to selectively activate and deactivate a power control signal 124 that is provided to a power manager 126 of the processing resource 112. Activating the power control signal 124 refers to asserting the power control signal 124 to an active state (e.g., a high state or a low state). Deactivating the power control signal 124 refers to de-asserting the power control signal 124 to an inactive state (e.g., a low state or a high state). Generally, the power control signal 124 is used to quickly adjust the power consumption of the processing resource 112.

An example of the power control signal 124 is a PROC_HOT (processor hot) signal. When the PROC_HOT signal is activated, the processing resource 112 enters into a reduced power mode. In an example, the reduced power mode includes the power manager 126 in the processing resource 112 setting a clock 128 in the processing resource 112 to operate at a low frequency (e.g., a minimum frequency such as 1 gigahertz (GHz) or some other low frequency). In this example, in response to the activation of the PROC_HOT signal, the power manager 126 sets the clock 128 to operate at the low frequency, which quickly reduces the power consumption of the processing resource 112. The clock 128 produces a clock signal oscillating at the operating frequency set by the power manager 126. Components operated at a lower operating frequency consume less power than components operated at a higher clock frequency

In further examples, in response to activation of the power control signal 124, the power manager 126 can alternatively or additionally control a voltage controller 130 in the processing resource 112 to output a low operating voltage for components inside the processing resource 112. The voltage controller 130 may be able to set the operating voltage of the processing resource 112 to one of several different voltage levels. Components of the processing resource 112 operated at a lower voltage level consume less power than components operated at a higher voltage level.

Components of the processing resource 112 coupled to the clock 128 and the voltage controller 130 include one or more processor cores 132, where a processing core is a processing unit of the processing resource 112 (the processing unit may execute machine-readable instructions). The processing resource 112 may further include other components, such as arithmetic logic units (ALUs), memories, and so forth, that receive a clock signal from the clock 128 and an operating voltage from the voltage controller 130.

If the power control signal 124 is deactivated by the quick reaction logic 122, then the power manager 126 can release the processing resource 112 from its reduced power mode (e.g., by allowing the operating frequency of the clock 128 to revert back to a higher operating frequency and/or allowing the voltage controller 130 to revert to a higher voltage level).

Placing the processing resource 112 into the reduced power mode in response to the activation of the power control signal 124 allows for the overall power consumption of the computing system 100 to be reduced quickly, which may prevent a fault or damage in the computing system 100 due to excessive power use. For example, if a power supply 104 fails, the remaining power supply (supplies) 104 in the power system 102 may not be able to supply adequate power at a current power consumption level at the time of power supply failure. If excessive power consumption causes the remaining power supply (supplies) 104 to trip, the computing system 100 may shut down unexpectedly, which can lead to data loss or corruption and loss of use of the computing system 100. As another example, if the temperature of the computing system 100 is elevated and power consumption is not quickly reduced to address the elevated temperature, damage to one or more components due to overheating may occur.

Although the power control signal 124 when activated can quickly place the processing resource 112 into the reduced power mode, this lower power mode may result in a relatively low performance level of the processing resource 112. In some cases, the processing resource 112 does not have to be operated at such a reduced operational mode in response to the critical power event 150. To address the foregoing, the iterative power adjustment logic 134 of the power capping engine 120 allows the power capping engine 120 to gradually increase (possibly in multiple iterations) the power consumption of the processing resource 112 until a power cap condition is reached. The iterative power adjustment logic 134 outputs a resource power capping parameter 136 to the power manager 126 of the processing resource 112, for reducing the power consumption of the processing resource 112 which in turn reduces the computing system's power consumption. The iterative power adjustment process performed by the iterative power adjustment logic 134 iteratively updates the value of the resource power capping parameter 136 based on power variables 138 received by the power capping engine 120. The power variables 138 represent a current power consumption in the computing system 100 and specified caps on power consumptions of the computing system 100 and the processing resource 112.

The power manager 126 monitors a current resource power consumption of the processing resource 112, and determines whether the current resource power consumption satisfies the current value of the resource power capping parameter 136. If the processing resource's current power consumption is too high relative to the current value of the resource power capping parameter 136, the power manager 126 reduces the power consumption of the processing resource 112, such as by reducing the operating frequency of the clock 128 and/or reducing the voltage level output by the voltage controller 130. If the processing resource's current power consumption is too low relative to the current value of the resource power capping parameter 136, the power manager 126 increases the power consumption of the processing resource 112, such as by increasing the operating frequency of the clock 128 and/or increasing the voltage level output by the voltage controller 130. The adjustment of the processing resource's power consumption according to the resource power capping parameter 136 is a relatively slow process as compared to the power adjustment performed in response to activation or deactivation of the power control signal 124.

In some examples, to achieve a quick response to the critical power event 150, the quick reaction logic 122 can be implemented using hardware processing circuitry in the management controller 110. The quick reaction logic 122 may further include machine-readable instructions (e.g., firmware or software) executed by the management controller 110 to perform a quick reaction power reduction process. In other examples, the quick reaction logic 122 can include a combination of hardware processing circuitry (e.g., a programmable logic device, a programmable integrated circuit, etc.) that is separate from the management controller, and machine-readable instructions executed by the management controller 110 to perform the quick reaction power reduction process.

The iterative power adjustment logic 134 can be implemented using machine-readable instructions (e.g., firmware or software) executed by the management controller 110.

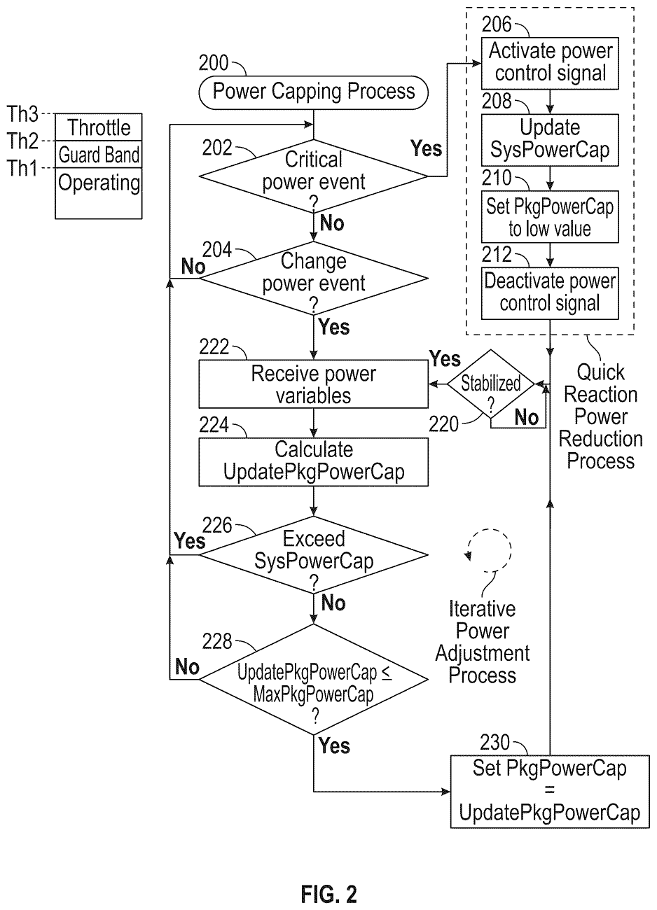

The management controller 110 can also receive a change power event 140, which is an event that affects the power of the computing system 100 but that is different from the critical power event 150. Examples of the change power event 140 can include any or some combination of the following: a modification of a system power capping parameter (which may have been requested by a user or another entity such as a program or machine), an overall power consumption of the computing system 100 exceeding one or more power thresholds (discussed in connection with FIG. 2) lower than the critical power threshold, a change in a power allocation for the computing system 100 (e.g., the power allocation for the computing system 100 in a computing environment such as a data center, a cloud environment, etc.).

The system power capping parameter represents a peak power that the computing system 100 may consume, and may be set to the lesser of the power allocated to the computing system 100 (such as in a computing environment), and the available power capability of the computing system 100.

The change power event 140 does not invoke the quick reaction logic 122, but rather can be handled by the iterative power adjustment logic 134. The change power event 140 is a power event that can be handled gradually without causing data loss, damage, a fault, or an error in the computing system 100.

FIG. 2 is a flow diagram of a power capping process 200 according to some examples of the present disclosure. The power capping process 200 can be performed by the power capping engine 120 of FIG. 1, for example. FIG. 2 shows a sequence of tasks. In other examples, the tasks may be performed in a different order, some of the tasks may be omitted, and other tasks may be added.

The power capping engine 120 determines (at 202) whether the critical power event 150 is detected. If so, the power capping engine 120 follows the “Yes” path from the decision block 202 to perform a quick reaction power reduction process. The quick reaction power reduction process includes tasks 206, 208, 210, and 212 in FIG. 2. Following the quick reaction power reduction process, the power capping engine 120 performs the iterative power adjustment process, which includes tasks 220-230.

If the critical power event 150 is not detected, the power capping engine 120 follows the “No” path of the decision block 202 to determine (at 204) whether the change power event 140 is detected. If so, the power capping engine 120 follows the “Yes” path from the decision block 204 to perform the iterative power adjustment process (without performing the quick reaction power reduction process). If the change power event 140 is not detected, then the power capping engine 120 follows the “No” path from the decision block 204 to return to the start of the power capping process 200.

As noted above, the critical power event 150 can include any or some combination of the following: a failure or fault of one or more power supplies in the computing system (e.g., if a redundant mode is not implemented where one power supply can take over providing power for a failed power supply), a current power consumption of the computing system exceeding the critical power threshold, or other conditions.

In the example of FIG. 2, the critical power threshold is represented as Th3. FIG. 2 also shows power thresholds Th1 and Th2, where Th2 is less than Th3, and Th1 is less than Th2. The current power consumption of the computing system 100 exceeding Th3 indicates that power consumption should be reduced quickly and thus the critical power event 150 is triggered (e.g., based on signals from the power system 102 of FIG. 1).

A region between Th2 and Th3 is referred to as a throttle region. The computing system 100 may be able to tolerate a power consumption in the throttle region for a first threshold time duration, such as on the order of hundreds of milliseconds. If the amount of time that the computing system 100 has operated in the throttle region exceeds the first threshold time duration, the change power event 140 is triggered (such as by the system firmware or another component of the computing system 100).

A region between Th1 and Th2 is referred to as a guard band region. The computing system 100 may be able to tolerate a power consumption in the guard band region for a second threshold time duration greater than the first threshold time duration, such as on the order of hundreds of seconds. If the amount of time that the computing system 100 has operated in the guard band region exceeds the second threshold time duration, the change power event 140 is triggered (such as by the system firmware or another component of the computing system 100).

A region below Th1 is the operating region of the computing system 100. The operating region represents the expected power consumption of the computing system 100 during normal operations. The threshold Th1 is also the system power capping parameter (SysPowerCap) of the computing system 100. SysPowerCap is based on a power allocation for the computing system 100, such as set in a computing environment that includes the computing system 100 as well as other computing systems.

The change power event 140 can also be triggered if the following conditions occur: a user or another entity modifies SysPowerCap, or a power allocation for the computing system 100 has changed such that SysPowerCap is less than or greater than the power allocation. For example, in response to changing conditions of a computing environment, the power allocations for different computing systems may be increased or decreased.

If the quick reaction power reduction process is triggered by the critical power event 150, the quick reaction logic 122 activates (at 206) the power control signal 124 (e.g., PROC_HOT) to cause the power manager 126 in the processing resource 112 to enter into the reduced power mode.

In an example where the quick reaction logic 122 is implemented with a combination of (1) a programmable logic device (or other hardware processing circuitry) separate from the management controller 110, and (2) machine-readable instructions executed in the management controller 110, the programmable logic device responds to the critical power event 150 by activating the power control signal 124 to the processing resource 112, and the programmable logic device further interrupts the management controller 110 to trigger further the remainder of the quick reaction power reduction process.

In another example where the quick reaction logic 122 is implemented entirely inside the management controller 110, the management controller 110 can activate the power control signal 124 to the processing resource 112 and perform the remainder of the quick reaction power reduction process.

In some examples, the quick reaction logic 122 may update (at 208) SysPowerCap. SysPowerCap may have been previously set to a specified value, such as based on a power allocation for the computing system 100. However, the power allocation may have since changed, which may be detected by the quick reaction logic 122. In response to a change in the power allocation for the computing system 100, the quick reaction logic 122 can update SysPowerCap.

The quick reaction logic 122 sets (at 210) the resource power capping parameter 136 (represented as PkgPowerCap in FIG. 2) to a minimum value (or another predefined low value). The minimum value corresponds to a minimum power consumption level according to which the power manager 126 is to manage power consumption at the processing resource 112. The predefined low value of PkgPowerCap causes the power manager 126 in the processing resource 112 to set the operating frequency of the clock 128 to a relatively low value and/or set the voltage controller 130 to output a relatively low operating voltage.

After setting PkgPowerCap to the predefined low value, the quick reaction logic 122 deactivates (at 212) the power control signal 124. While the power control signal 124 is active, the power manager 126 would disregard PkgPowerCap. However, once the power control signal 124 is deactivated, the power manager 126 manages power consumption of the processing resource 112 according to PkgPowerCap.

The power capping engine 120 then proceeds to the iterative power adjustment process, which includes the iterative power adjustment logic 134 waiting (at 220) for stabilization of a power adjustment in the processing resource 112, such as based on an updated value of PkgPowerCap. The iterative power adjustment logic 134 waits a specified stabilization duration to allow the processing resource 112 to reach a stable operating point as the power manager 126 adjusts the power consumption of the processing resource 112 according to the value of v. As noted above, adjusting the processing resource's power consumption according to PkgPowerCap is a relatively slow process (which may take longer than 50 ms or some other time period). The specified stabilization duration can be configured in the power manager 126, such as by an administrator or another entity.

After expiration of the specified stabilization duration, the iterative power adjustment logic 134 performs the next iteration of the iterative power adjustment process. The iterative power adjustment logic 134 receives (at 222) the power variables 138. For example, the iterative power adjustment logic 134 can read the power variables 138 from a memory.

In some examples, as shown in FIG. 2, the power variables 138 include the following: PkgPowerCap (which is the current value of the resource power capping parameter 136 and represents a current power consumption cap of the processing resource 112), MaxPkgPowerCap (which represents the maximum power consumption cap of the processing resource 112), SysPowerCap, and SysPowerConsumption (which represents a current power consumption of the computing system 100). MaxPkgPowerCap sets the maximum value for PkgPowerCap (i.e., PkgPowerCap is not allowed to go above MaxPkgPowerCap).

Based on the power variables 138, the iterative power adjustment logic 134 calculates (at 224) an updated power capping parameter value (represented as UpdatePkgPowerCap in FIG. 2). The variable PkgPowerCap (the resource power capping parameter 136) is iteratively updated using new values of UpdatePkgPowerCap by the iterative power adjustment logic 134 in successive iterations of the iterative power adjustment process.

The variable UpdatePkgPowerCap is calculated as follows:

$$UpdatePkgPowerCap = PkgPowerCap + ( PkgPowerCap - SysPowerConsumption ) / 2.$$

In each iteration, the variable UpdatePkgPowerCap is calculated based on the current value of PkgPowerCap and the current power consumption of the computing system 100 (as represented by SysPowerConsumption). Such a calculation of UpdatePkgPowerCap is an example of the Newtonian search algorithm. In other examples, other techniques of calculating new values of UpdatePkgPowerCap can use different scaling factors of the difference between PkgPowerCap and SysPowerConsumption.

The iterative power adjustment logic 134 determines (at 226) whether the new value of UpdatePkgPowerCap computed in the current iteration will cause the computing system's power consumption to exceed SysPowerCap. More specifically, the iterative power adjustment logic 134 checks if the following condition is true:

$$SysPowerCap > UpdatePkgPowerCap + ( SysPowerCap - SysPowerConsumption ) .$$

In the above, (SysPowerCap-SysPowerConsumption) represents the difference between the computing system's current power consumption and the system power capping parameter (SysPowerCap). If setting the processing resource 112 to operate according to the new value of UpdatePkgPowerCap would cause SysPowerCap to be exceeded, then the iterative power adjustment logic 134 follows the “Yes” path from the decision block 226 and the power capping engine 120 returns to the beginning of the power capping process 200 (effectively exiting the iterative power adjustment process).

However, if setting the processing resource 112 to operate according to the new value of UpdatePkgPowerCap would not cause SysPowerCap to be exceeded, then the iterative power adjustment logic 134 follows the “No” path from the decision block 226, and proceeds to block 228. In block 228, the iterative power adjustment logic 134 determines if the new value of UpdatePkgPowerCap is less than or equal to MaxPkgPowerCap. If not, the iterative power adjustment logic 134 follows the “No” path from the decision block 228 to return to the beginning of the power capping process 200.

However, if the iterative power adjustment logic 134 determines (at 228) that the new value of UpdatePkgPowerCap is less than or equal to MaxPkgPowerCap, the iterative power adjustment logic 134 follows the “Yes” path from the decision block 228, and proceeds to block 230. In block 230, the iterative power adjustment logic 134 sets (updates) PkgPowerCap to equal Updated PkgPowerCap. The iterative power adjustment logic 134 outputs the updated PkgPowerCap value to the processing resource 112, to cause a power adjustment at the processing resource 112.

Next, the iterative power adjustment logic 134 proceeds to wait (at 220) for stabilization of the power adjustment in the processing resource 112 according to the updated PkgPowerCap value, before proceeding to the next iteration of the iterative power adjustment process.

The iterative power adjustment logic 134 proceeds through successive iterations of the iterative power adjustment process until the checks performed at 226 and 228 cause an exit from the iterative power adjustment process.

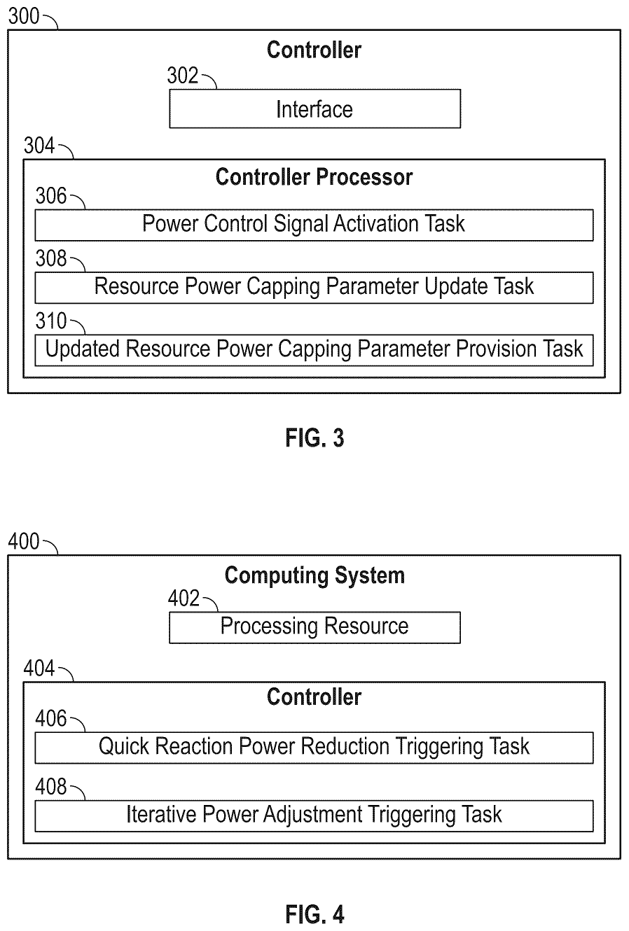

FIG. 3 is a block diagram of a controller 300 according to some examples. The controller 300 may be implemented using a single integrated circuit device or multiple integrated circuit devices. For example, the controller 300 may be implemented with the management controller 110 of FIG. 1. As another example, the controller 300 may be implemented with the management controller 110 of FIG. 1 and a separate programmable logic device (or another type of hardware processing circuitry).

The controller 300 includes an interface 302 to a processing resource of a computing system. The interface 302 may be a bus interface or another type of communication interface to allow the controller 300 to communicate over a bus or another type of communication link with the processing resource. Note that the controller 300 may be directly connected to the processing resource without an intervening device between the controller 300 and the processing resource, or alternatively, the controller 300 may be indirectly connected to the processing resource with one or more intervening devices between the controller 300 and the processing resource.

The controller 300 includes a controller processor 304 to perform various tasks. The tasks of the controller processor 304 can be performed by hardware processing circuitry and/or by machine-readable instructions. The controller processor 304 may be implemented using one or more processing devices.

The tasks of the controller processor 304 include a power control signal activation task 306 to activate, as a response to an event, a power control signal to the processing resource through the interface 302. The activated power control signal (e.g., PROC_HOT) places the processing resource in a reduced power mode, such as by setting an operating frequency of a clock in the processing resource to a minimum or other low frequency, and/or setting an operating voltage provided by a voltage controller in the processing resource to a minimum or other low voltage. Activating the power control signal is part of the quick reaction power reduction process.

The tasks of the controller processor 304 include a resource power capping parameter update task 308 to update a value of a resource power capping parameter in an iterative power adjustment process. An example of the resource power capping parameter is PkgPowerCap.

The tasks of the controller processor 304 include an updated resource power capping parameter provision task 310 to, in an iteration of the iterative power adjustment process, provide the updated value of the resource power capping parameter to the processing resource to set a power consumption cap of the processing resource. The processing resource can include a power manager (e.g., 126 in FIG. 1) to manage the power consumption of the processing resource according to the updated value of the resource power capping parameter.

In some examples, after activating the power control signal to the processing resource, the controller processor 304 sets the resource power capping parameter to a minimum value. Setting the resource power capping parameter to the minimum value is part of the quick reaction power reduction process.

In some examples, after setting the resource power capping parameter to the minimum value, the controller processor 304 deactivates the power control signal to the processing resource. The iterative power adjustment process is initiated after deactivating the power control signal to the processing resource.

In some examples, the controller processor 304 waits a specified stabilization duration after deactivating the power control signal before initiating the iterative power adjustment process.

In some examples, the updated value of the resource power capping parameter causes the processing resource to adjust one or more of an operating frequency of the processing resource or a voltage of the processing resource to restrict an amount of power consumed by the processing resource according to the power consumption cap.

In some examples, the iterative power adjustment process updates the resource power capping parameter based on a current value of the resource power capping parameter and a current power consumption of the computing system (e.g., SysPowerConsumption).

In some examples, the iterative power adjustment process updates the resource power capping parameter based on the current value of the resource power capping parameter and a difference between a system power capping parameter and the current power consumption of the computing system.

In some examples, the iterative power adjustment process updates the resource power capping parameter based on the current value of the resource power capping parameter and a scaled value of the difference. For example, the update is according to:

$$UpdatePkgPowerCap = PkgPowerCap + ( PkgPowerCap - SysPowerConsumption ) / 2.$$

In some examples, the controller processor 304 determines whether the updated resource power capping parameter would cause the system power capping parameter to be exceeded, such as the determination 226 in FIG. 2. The controller processor 304 proceeds with a next iteration of the iterative power adjustment process in response to determining that the updated resource power capping parameter would not cause the system power capping parameter to be exceeded.

In some examples, the controller processor 304 exits the iterative power adjustment process in response to determining that the updated resource power capping parameter would cause the system power capping parameter to be exceeded.

In some examples, the controller processor 304 determines whether the updated value of the resource power capping parameter exceeds a maximum value of the resource power capping parameter (e.g., whether UpdatePkgPowerCap≤MaxPkgPowerCap). The controller processor 304 proceeds with a next iteration of the iterative power adjustment process in response to determining that the updated value of the resource power capping parameter does not exceed the maximum value.

In some examples, the controller processor 304 exits the iterative power adjustment process in response to determining that the updated value of the resource power capping parameter exceeds the maximum value.

In some examples, the activating of the power control signal as the response to the event is part of a quick reaction power reduction process, and the iterative power adjustment process iteratively adjusts power consumption of the processing resource in a plurality of iterations.

In some examples, the event (e.g., the critical power event 150 of FIG. 1) is responsive to one or more of a power supply becoming unavailable, a power consumption of the computing system exceeding a critical power threshold, or a temperature of the computing system exceeding a temperature threshold.

In some examples, the controller processor 304 triggers the iterative power adjustment process but not the quick reaction power reduction process in response to a further event (e.g., the change power event 140 of FIG. 1).

In some examples, the further event is responsive to one or more of a modification of a power consumption cap for the computing system, a power consumption of the computing system exceeding a first power threshold that is less than a critical power threshold, or a change in a power allocation for the computing system.

FIG. 4 is a block diagram of a computing system 400 according to some examples. An example of the computing system 400 is the computing system 100 of FIG. 1. The computing system 400 includes a processing resource 402 and a controller 404 to perform various tasks.

The tasks of the controller 404 include a quick reaction power reduction trigger task 406 to, in response to a power event, trigger a quick reaction power reduction process of the controller that includes activating a power control signal to place the processing resource in a reduced power mode. An example of the power control signal is the PROC_HOT signal.

The tasks of the controller 404 include an iterative power adjustment triggering task 408 to, after the quick reaction power reduction process, trigger an iterative power adjustment process to iteratively update a resource power capping parameter to set a power consumption cap of the processing resource.

In some examples, as part of the quick reaction power reduction process, the controller 404 sets the resource power capping parameter to a minimum value, and after setting the resource power capping parameter to the minimum value, deactivates the power control signal to allow the processing resource to adjust a power consumption of the processing resource according to the minimum value of the resource power capping parameter. As part of the iterative power adjustment process, the controller 404 iteratively increases a value of the resource power capping parameter in a plurality of iterations.

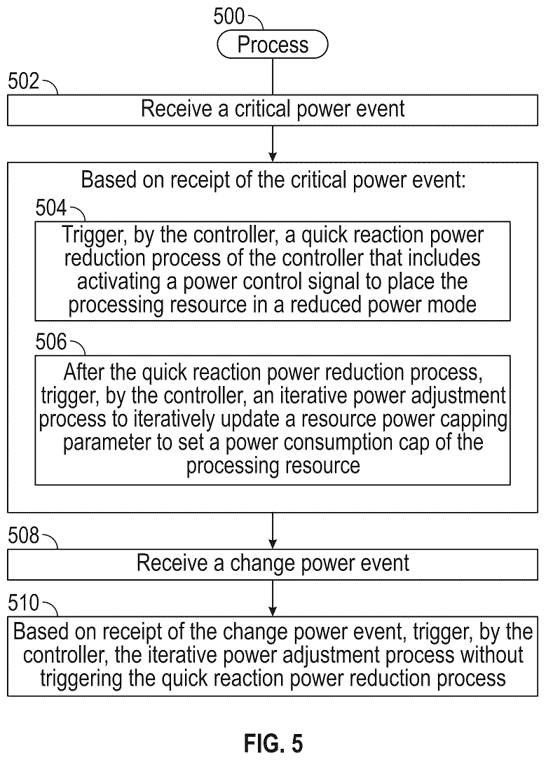

FIG. 5 is a flow diagram of a process 500 according to some examples. The process 500 may be performed by a controller.

The process 500 includes receiving (at 502) a critical power event. An example of the critical power event is the critical power event 150 of FIG. 1.

Based on receipt of the critical power event, the process 500 includes triggering (at 504), by the controller, a quick reaction power reduction process of the controller that includes activating a power control signal to place the processing resource in a reduced power mode, and after the quick reaction power reduction process, triggering (at 506), by the controller, an iterative power adjustment process to iteratively update a resource power capping parameter to set a power consumption cap of the processing resource.

The process 500 includes receiving (at 508) a change power event. An example of the change power event is the change power event 140 of FIG. 1.

Based on receipt of the change power event, the process 500 includes triggering (at 510), by the controller, the iterative power adjustment process without triggering the quick reaction power reduction process.

As used here, a “computer” can refer to any or some combination of a desktop computer, a notebook computer, a server computer, a communication node, a storage system, or another type of electronic device.

A “compute element” can refer to any physical element or virtual element that is able to perform processing tasks.

As used here, a “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

A “BMC” can refer to a specialized service controller that monitors the physical state of a computing system using sensors and communicates with a remote management system (that is remote from the computing system) through an independent “out-of-band” connection. The BMC can perform management tasks to manage components of the computing system. Examples of management tasks that can be performed by the BMC can include any or some combination of the following: power control to perform power management of the computing system (such as to transition the computing system between different power consumption states in response to detected events), thermal monitoring and control of the computing system (such as to monitor temperatures of the computing system and to control thermal management states of the computing system), fan control of fans in the computing system, system health monitoring based on monitoring measurement data from various sensors of the computing system, remote access of the computing system (to access the computing system over a network, for example), remote reboot of the computing system (to trigger the computing system to reboot using a remote command), system setup and deployment of the computing system, system security to implement security procedures in the computing system, and so forth.

In some examples, the BMC can provide so-called “lights-out” functionality for a computing system. The lights out functionality may allow a user, such as a systems administrator, to perform management operations on the computing system even if an OS is not installed or not functional on the computing system.

Moreover, in some examples, the BMC can run on auxiliary power provided by an auxiliary power supply (e.g., a battery); as a result, the computing system does not have to be powered on to allow the BMC to perform the BMC's operations. The auxiliary power supply is separate from a main power supply that supplies powers to other components (e.g., a main processor, a memory, an I/O device, etc.) of the computing system.

A hardware processor can include a microprocessor, a core of a multi-core microprocessor, a microcontroller, a programmable integrated circuit, a programmable gate array, or another hardware processing circuit. Machine-readable instructions executable on a hardware processor can refer to the instructions executable on a single hardware processor or the instructions executable on multiple hardware processors.

A storage medium can store machine-readable instructions executable by one or more hardware processors to perform tasks. A storage medium can include any or some combination of the following: a semiconductor memory device such as a dynamic or static random access memory (a DRAM or SRAM), an erasable and programmable read-only memory (EPROM), an electrically erasable and programmable read-only memory (EEPROM), or flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A controller comprising:
an interface to a processing resource of a computing system; and
a controller processor to:
activate, as a response to an event, a power control signal to the processing resource through the interface, the activated power control signal to place the processing resource in a reduced power mode;
update a value of a resource power capping parameter in an iterative power adjustment process; and
in an iteration of the iterative power adjustment process, provide the updated value of the resource power capping parameter to the processing resource to set a power consumption cap of the processing resource.

2. The controller of claim 1, wherein the controller processor is to:
after activating the power control signal to the processing resource, set the resource power capping parameter to a minimum value.

3. The controller of claim 2, wherein the controller processor is to:
after setting the resource power capping parameter to the minimum value, deactivate the power control signal to the processing resource,
wherein the iterative power adjustment process to update the value of the resource power capping parameter is initiated after deactivating the power control signal to the processing resource.

4. The controller of claim 3, wherein the controller processor is to:
wait a specified stabilization duration after deactivating the power control signal before initiating the iterative power adjustment process.

5. The controller of claim 1, wherein the updated value of the resource power capping parameter causes the processing resource to adjust one or more of an operating frequency of the processing resource or a voltage of the processing resource to restrict an amount of power consumed by the processing resource according to the power consumption cap.

6. The controller of claim 1, wherein the iterative power adjustment process updates the resource power capping parameter based on a current value of the resource power capping parameter and a current power consumption of the computing system.

7. The controller of claim 6, wherein the iterative power adjustment process updates the resource power capping parameter based on the current value of the resource power capping parameter and a difference between a system power capping parameter and the current power consumption of the computing system.

8. The controller of claim 7, wherein the iterative power adjustment process updates the resource power capping parameter based on the current value of the resource power capping parameter and a scaled value of the difference.

9. The controller of claim 7, wherein the controller processor is to:
determine whether the updated resource power capping parameter would cause the system power capping parameter to be exceeded;
proceed with a next iteration of the iterative power adjustment process in response to determining that the updated resource power capping parameter would not cause the system power capping parameter to be exceeded.

10. The controller of claim 9, wherein the controller processor is to:
exit the iterative power adjustment process in response to determining that the updated resource power capping parameter would cause the system power capping parameter to be exceeded.

11. The controller of claim 1, wherein the controller processor is to:
determine whether the updated value of the resource power capping parameter exceeds a maximum value of the resource power capping parameter; and
proceed with a next iteration of the iterative power adjustment process in response to determining that the updated value of the resource power capping parameter does not exceed the maximum value.

12. The controller of claim 11, wherein the controller processor is to:
exit the iterative power adjustment process in response to determining that the updated value of the resource power capping parameter exceeds the maximum value.

13. The controller of claim 1, wherein the activating of the power control signal as the response to the event is part of a quick reaction power reduction process, and wherein the iterative power adjustment process iteratively adjusts power consumption of the processing resource in a plurality of iterations.

14. The controller of claim 13, wherein the event is responsive to one or more of:
a power supply becoming unavailable,
a power consumption of the computing system exceeding a critical power threshold, or
a temperature of the computing system exceeding a temperature threshold.

15. The controller of claim 13, wherein the controller processor is to:
trigger the iterative power adjustment process but not the quick reaction power reduction process in response to a further event.

16. The controller of claim 15, wherein the further event is responsive to one or more of:
a modification of a power consumption cap for the computing system,
a power consumption of the computing system exceeding a first power threshold that is less than a critical power threshold, or
a change in a power allocation for the computing system.

17. A computing system comprising:
a processing resource; and
a controller to:
in response to a power event, trigger a quick reaction power reduction process of the controller that includes activating a power control signal to place the processing resource in a reduced power mode; and
after the quick reaction power reduction process, trigger an iterative power adjustment process to iteratively update a resource power capping parameter to set a power consumption cap of the processing resource.

18. The computing system of claim 17, wherein the controller is to:
as part of the quick reaction power reduction process:
set the resource power capping parameter to a minimum value, and
after setting the resource power capping parameter to the minimum value, deactivate the power control signal to allow the processing resource to adjust a power consumption of the processing resource according to the minimum value of the resource power capping parameter; and
as part of the iterative power adjustment process, iteratively increase a value of the resource power capping parameter in a plurality of iterations.

19. A method of a computing system, comprising:
receiving a critical power event;
based on receipt of the critical power event:
triggering, by a controller, a quick reaction power reduction process of the controller that includes activating a power control signal to place a processing resource in a reduced power mode, and
after the quick reaction power reduction process, triggering, by the controller, an iterative power adjustment process to iteratively update a resource power capping parameter to set a power consumption cap of the processing resource;
receiving a change power event; and
based on receipt of the change power event, triggering, by the controller, the iterative power adjustment process without triggering the quick reaction power reduction process.

20. The method of claim 19, wherein an updated value of the resource power capping parameter causes the processing resource to adjust one or more of an operating frequency of the processing resource or a voltage of the processing resource to restrict an amount of power consumed by the processing resource.
